(19) United States
(12) Patent Application Publication
(10) Pub. No.: US 2010/0195145 A1
(43) Pub. Date: Aug. 5, 2010

(54) IMAGE PROCESSING APPARATUS, CONTROL METHOD FOR IMAGE PROCESSING APPARATUS, AND STORAGE MEDIUM STORING CONTROL PROGRAM THEREFOR

(75) Inventor: Tomoko Adachi, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/652,240

(22) Filed: Jan. 5, 2010

(30) Foreign Application Priority Data
Jan. 6, 2009 (JP) 2009-000878

(51) Int. Cl. G06F 15/00

(52) U.S. Cl. 358/1.15

(57) ABSTRACT

An image processing apparatus that is capable of reducing a burden on a user when performing an input operation of a unique setting value to an image processing apparatus that is newly added to a system. An acquisition unit acquires a unique setting value from at least one selected from the other image processing apparatuses via the network, the unique setting value being unique to the selected image processing apparatus among setting values set to the selected image processing apparatus concerned. A display unit displays a setting screen that includes a reference area for displaying the unique setting value acquired by the acquisition unit as a reference value, and an input area for inputting the unique setting value that is set up to the image processing apparatus itself.

### BACKGROUND OF THE INVENTION

1. Field of the Invention

The present invention relates to an image processing apparatus that is connected to a network to communicate with a plurality of image processing apparatuses such as digital multifunctional peripheral devices that exist on the network, to a control method for the image processing apparatus, and to storage medium storing a control program therefor.

2. Description of the Related Art

Conventionally, a device-setting apparatus that sets up setup information corresponding to each target device to a plurality of target devices connected to a network has been proposed (see Japanese laid-open patent publication (Kokai) No. 2005-197935 (JP2005-197935A)).

The device-setting apparatus receives collective-setting information that is linked to identification information, which identifies each of the target devices on the network, and device-specific setting information, which should be set to each of the target devices, first. On the basis of the batch-setup information, the device-setting apparatus identifies each target device on the network according to the identification information, and sets up the device-specific setting information to the target devices through the network at a time (a batch setting).

However, in the system disclosed in the above-mentioned publication, the device-setting apparatus needs to hold the device-specific setting information in conjunction with the identification information of the target devices beforehand. Moreover, since the device-setting apparatus merely sets the setting information to the target devices at a time, convenience about an input operation for a unique setting value that cannot be set up by the batch setting is not taken into consideration.

### SUMMARY OF THE INVENTION

The present invention provides an image processing apparatus, a control method for the image processing apparatus, and a control program therefor, which are capable of reducing a burden on a user when performing an input operation of a unique setting value to an image processing apparatus that is newly added to a system.

Accordingly, a first aspect of the present invention provides an image processing apparatus that is connected to a network to communicate with a plurality of other image processing apparatuses that exist on the network, the image processing apparatus comprising an acquisition unit adapted to acquire a unique setting value from at least one selected from the other image processing apparatuses via the network, the unique setting value being unique to the selected image processing apparatus among setting values set to the selected image processing apparatus concerned, and a display unit adapted to display a setting screen that includes a reference area for displaying the unique setting value acquired by the acquisition unit as a reference value, and an input area for inputting the unique setting value that is set up to the image processing apparatus itself.

Accordingly, a second aspect of the present invention provides a control method for an image processing apparatus that is connected to a network to communicate with a plurality of other image processing apparatuses that exist on the network, the control method comprising an acquisition step of acquiring a unique setting value from at least one selected from the other image processing apparatuses via the network, the unique setting value being unique to the selected image processing apparatus among setting values set to the selected image processing apparatus concerned, and a display step of displaying a setting screen that includes a reference area for displaying the unique setting value acquired in the acquisition step as a reference value, and an input area for inputting the unique setting value that is set up to the image processing apparatus itself.

Accordingly, a third aspect of the present invention provides a computer-readable storage medium storing a control program to execute a control method for an image processing apparatus that is connected to a network to communicate with a plurality of other image processing apparatuses that exist on the network, the control method comprising an acquisition step of acquiring a unique setting value from at least one selected from the other image processing apparatuses via the network, the unique setting value being unique to the selected image processing apparatus among setting values set to the selected image processing apparatus concerned, and a display step of displaying a setting screen that includes a reference area for displaying the unique setting value acquired in the acquisition step as a reference value, and an input area for inputting the unique setting value that is set up to the image processing apparatus itself.

According to the present invention, the burden on the user when performing the input operation of the unique setting value to the image processing apparatus that is newly added to the system can be reduced.

Further features of the present invention will become apparent from the following description of exemplary embodiments with reference to the attached drawings.

### BRIEF DESCRIPTION OF THE DRAWINGS

FIG. 1 is a view schematically showing a configuration example of a system including an image processing apparatus according to a first embodiment of the present invention.

FIG. 2 is a block diagram schematically showing a basic configuration of the image processing apparatus.

FIG. 3 is a view showing an example of a screen displayed on an operation unit of the image processing apparatus.

FIG. 4 is a view showing an example of a screen displayed on the operation unit of the image processing apparatus when performing a network setting.

FIGS. 5A and 5B are views showing an example of a list including common setting values and unique setting values.

FIG. 6 is a view showing another example of a list including the common setting values and the unique setting values.

FIG. 7 is a view showing an example of a screen for setting the unique setting values displayed on the operation unit of the image processing apparatus.

FIG. 8 is a flowchart showing a setting process of the unique setting values in the image processing apparatus.

FIG. 9 is a view showing an example of a setting screen displayed on the operation unit of the image processing apparatus, when unique setting values corresponds to reference values of two models of image processing apparatuses.

FIG. 10 is a flowchart showing the setting process in step S1018 in FIG. 8.

FIG. 11 is a view showing an example of a screen for setting abbreviated user name displayed on an operation unit of an image processing apparatus according to a second embodiment of the present invention.

FIG. 12 is a flowchart showing a process executed by a control unit in place of the process in step S1010 in FIG. 8.

### DESCRIPTION OF THE EMBODIMENTS

Hereafter, embodiments according to the present invention will be described in detail with reference to the drawings.

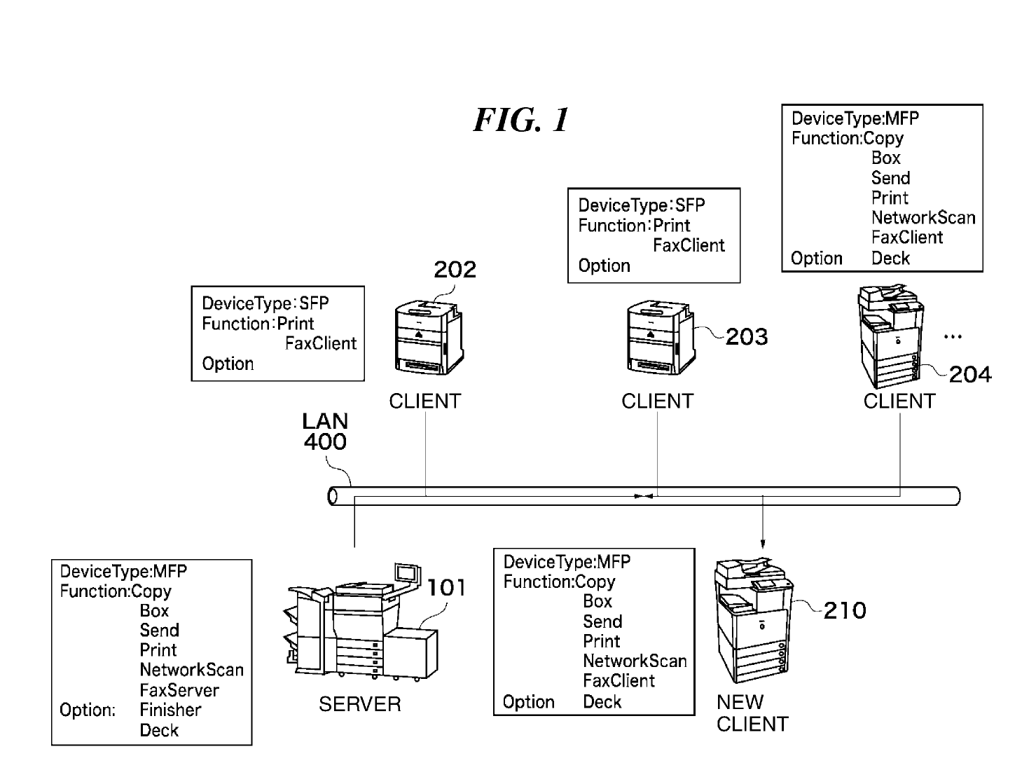

FIG. 1 is a view schematically showing a configuration example of a system including an image processing apparatus according to a first embodiment of the present invention.

As shown in FIG. 1, the image processing system of this embodiment comprises a plurality of image processing apparatuses 101, 202, 203, 204 and 210 that can communicate with one another via a LAN 400 etc.

In this embodiment, the image processing apparatus (MFP) 101 serves as a server, the image processing apparatuses (SFPs) 202, 203 and the image processing apparatus (MFP) 204 serve as existing clients, and the image processing apparatus (MFP) 210 serves as a new client.

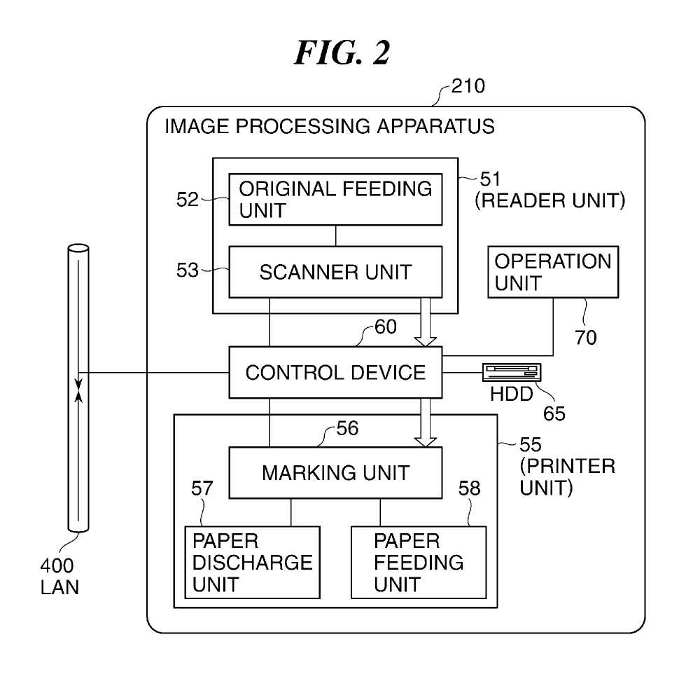

Next, a basic configuration of the image processing apparatus 210 as the new client will be described with reference to FIG. 2,

As shown in FIG. 2, the image processing apparatus 210 is provided with a reader unit 51, a printer unit 55, a control device 60, an operation unit 70, and a hard disk drive (HDD) 65.

The reader unit 51 reads an image of an original optically, and converts the read image into image data. The reader unit 51 comprises a scanner unit 53 having a function for reading an image of an original and an original feeding unit 52 having a function for feeding an original. It should be noted that some models do not have the original feeding unit 52.

The printer unit 55 feeds a recording paper, prints an image on the recording paper, and discharges the paper outside the apparatus. The printer unit 55 comprises a paper feeding unit 58 having a plurality of types of recording paper cassettes, a marking unit 56 that transfers and fixes the image data onto the recording paper, and a discharge unit 57 that sorts, staples, and discharges the printed recording paper outside the apparatus.

The control device 60 is electrically connected to the reader unit 51 and the printer unit 55, and also is connected to the LAN 400. The control device 60 provides a copy function by controlling the reader unit 51 to read an image of an original and by controlling the printer unit 55 to output the image data read by the reader unit 51 onto a recording paper.

Moreover, the control device 60 provides a network scanner function by converting the image data read by the reader unit 51 into code data and by transmitting the code data to a host computer (not shown) via the LAN 400. Furthermore, the control device 60 provides a printer function by converting the code data received via the LAN 400 from the host computer into image data and by outputting the image data to the printer unit 55.

The operation unit 70 has a liquid crystal display unit, a touch-panel input device adhered to the liquid crystal display unit, and a plurality of hard keys, and provides a user I/F to which a user performs various operations. A signal inputted via the touch-panel input device or the hard key is transmitted to the control device 60. The liquid crystal display unit displays image data sent from the control device 60. Moreover, the operation unit 70 provides a box function (a document storing function) to store data of the original read by the reader unit 51 into the HDD 65 as a document. This box function is provided with a function to print stored document in addition to the document storing function. The basic configuration shown in FIG. 2 is common to the server 101 and the clients 202, 203, and 204. For example, the clients (SFPs) 202 and 203 are configured by omitting the reader unit from the basic configuration, and the server (MFP) 101 is provided with a finisher for performing a stapling process and a sorting process in addition to the basic configuration.

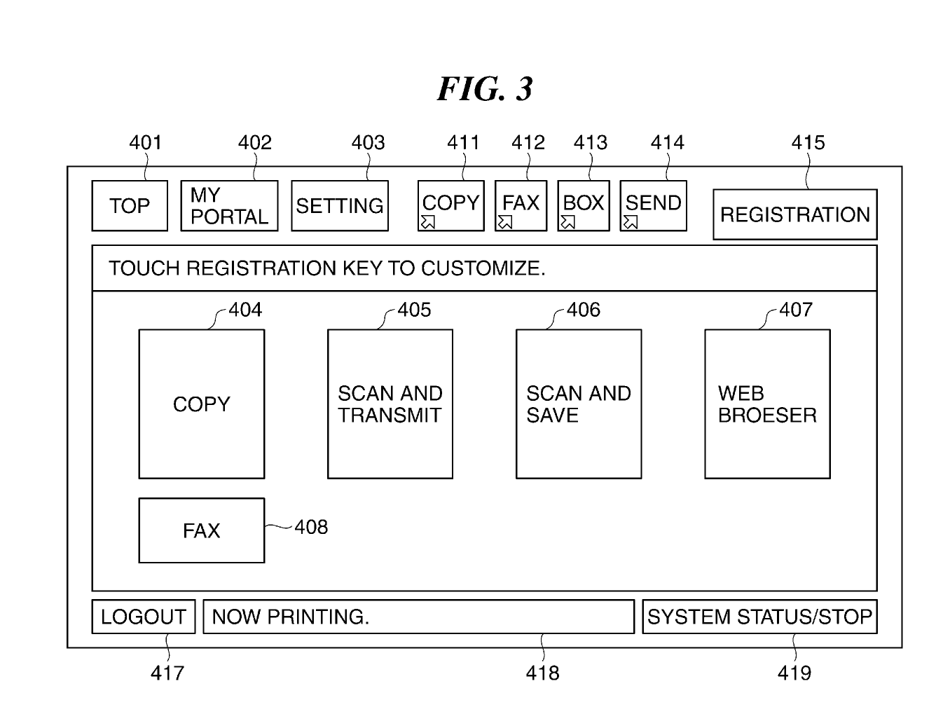

Next, an example of a screen displayed on the operation unit 70 of the image processing apparatus 210 will be described with reference to FIG. 3.

In FIG. 3, a top menu key 401 is a key prepared to return to a top menu screen (a login screen, not shown). Touching a my-portal key 402, a screen that only appears information about a specific login user (information about a job started by the user) is displayed.

A setting key 403 is used to display a screen for setting environmental information such as a setting value that a device has, a network setting, an application, and a setting value for each user. Keys 404 through 408 are various function keys, and keys 411 through 414 are shortcut keys to various functions. A registration key 415 is a key for editing a personalization screen.

A key 417 is a key for logging out, and a status line 418 is an area in which information about an active job or warning information about a consumable item (toner etc.), for example, is displayed. A system status key 419 is a key for displaying a screen to browse information about a list of active jobs or a job log list, for example.

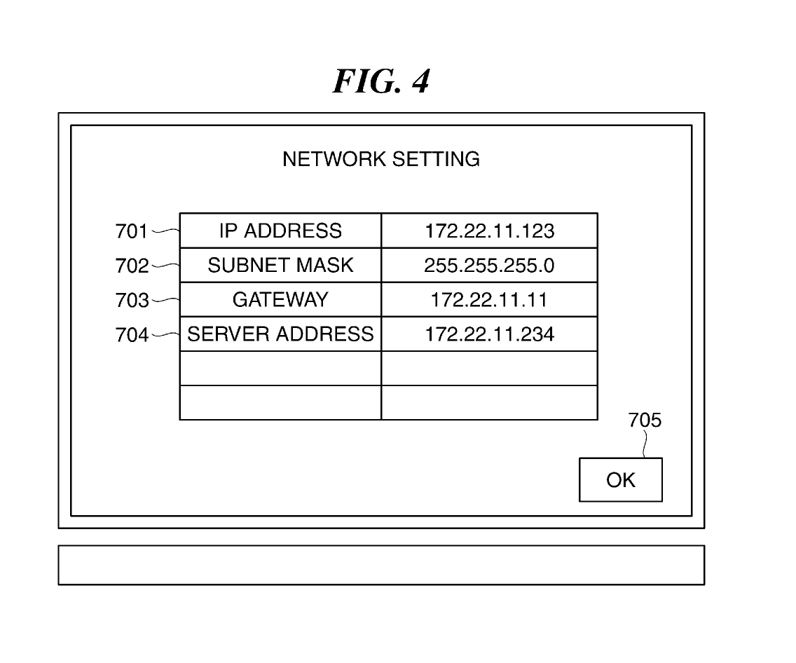

FIG. 4 is a view showing an example of a screen displayed on the operation unit 70 of the image processing apparatus 210 when performing a network setting.

In this screen, an IP address setting section 701, a subnet mask setting section 702, a gateway setting section 703, and a server address setting section 704 are displayed. In the operation unit 70 of the image processing apparatus 210, a user configures a relation between a client and a server by setting a server address according to this screen, and is newly added to the image processing system shown in FIG. 1.

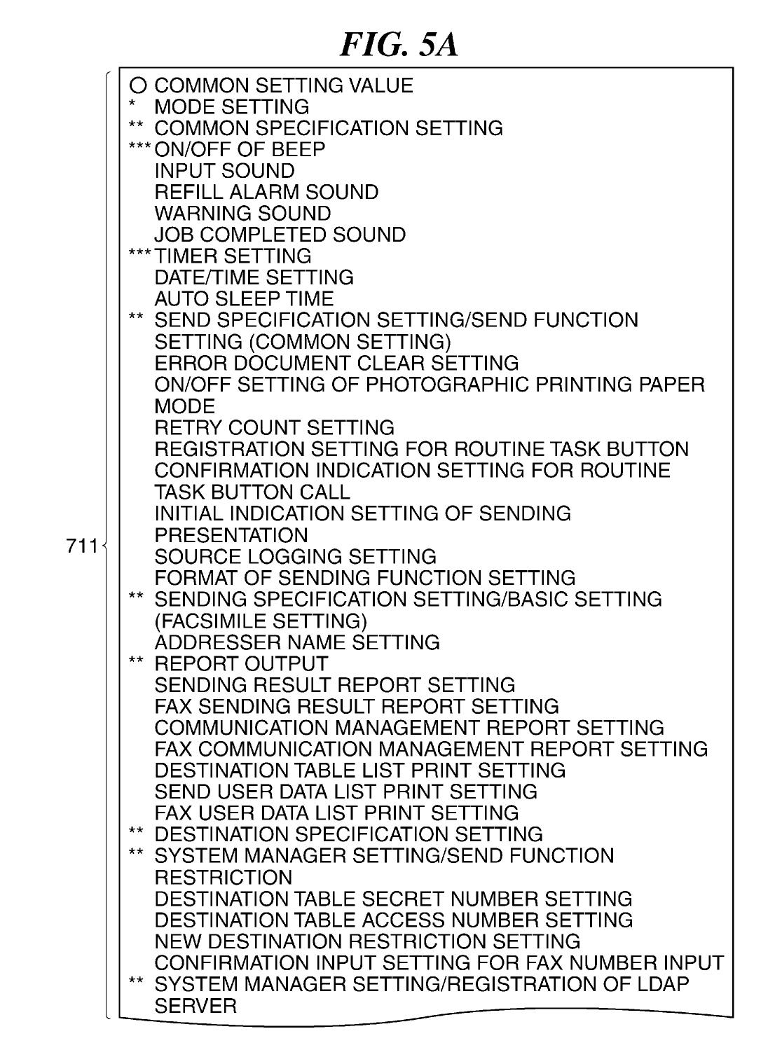

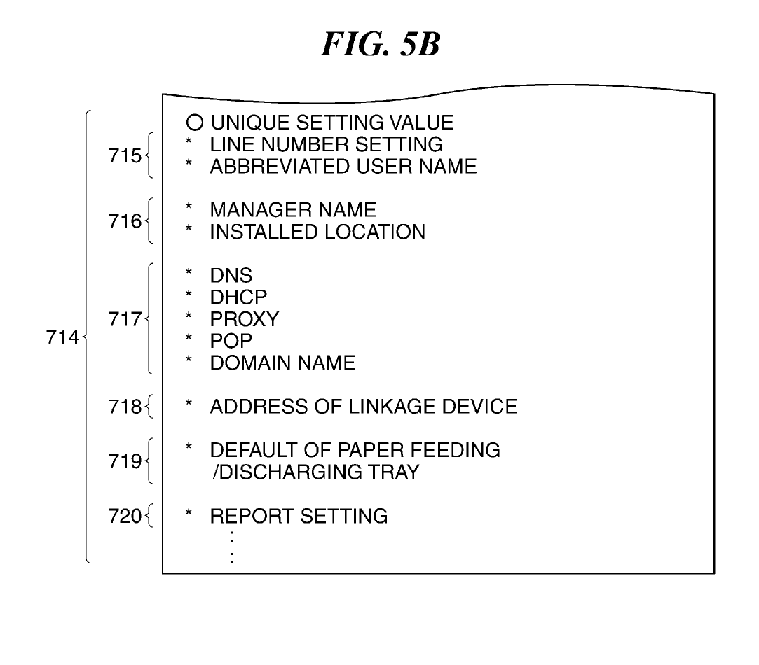

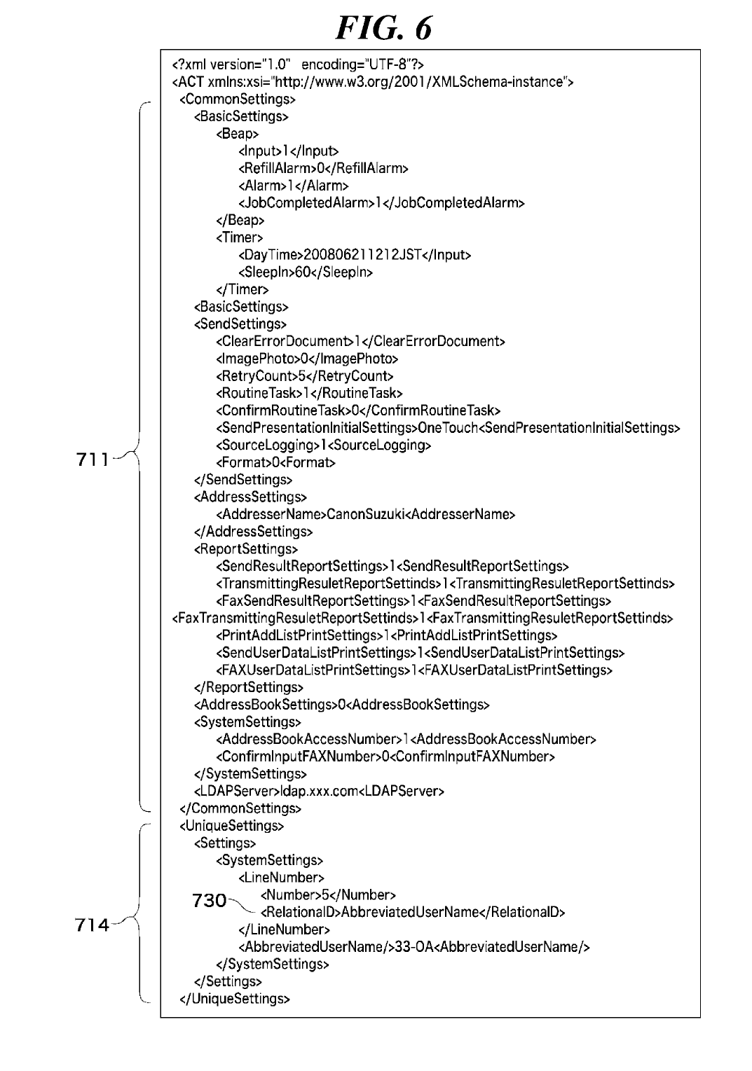

FIGS. 5A to FIG. 6 are views showing an example of a list including common setting values and unique setting values.

The contents of the common setting values 711 and the unique setting values 714 shown in FIGS. 5A and 53 are stored in the HOD etc. of the image processing apparatus as a client in the language (for example, XML (Extensible Markup Language)) shown in FIG. 6. The common setting values 711 can be copied as-is from an image processing apparatus as another client, when the image processing apparatus 210 is added to the image processing system shown in FIG. 1 as a new client.

When the image processing apparatus 210 as the new client performs the above-mentioned server setting to the image processing apparatus 101 as the server, the image processing apparatus 101 acquires device information from the image processing apparatus 210. The device information includes a device type, a function, and an option as shown in FIG. 1.

The image processing apparatus 101 refers to the device type in the device information. Since the image processing apparatus 210 is the MFP, the image processing apparatus 101 selects the image processing apparatus 204 as a source apparatus of the common setting value 711 from among the other image processing apparatuses 202, 203, and 204.

It should be noted that when a plurality of MFPs exist in the other image processing apparatuses as the clients, the image processing apparatus 101 refers to the function and the option in the device information of the image processing apparatus 210.

The image processing apparatus 101 selects an image processing apparatus with the device information of nearest to the image processing apparatus 210 as the source of the common setting values 711, and transmits the common setting values 711 of the selected image processing apparatus to the image processing apparatus 210. The image processing apparatus 210 sets up the acquired common setting values 711 as the common setting values, and stores into the HDD 65 etc.

After setting up the common setting values, a setting screen for the unique setting values is displayed on the operation unit 70 of the image processing apparatus 210.

When displaying the setting screen, setting value information corresponding to the unique setting values 714 is acquired from the other image processing apparatuses as the clients connected to the network via the image processing apparatus 101 as reference values, and is displayed in parallel to a input form for the setting values.

A user establishes the unique setting values on the setting screen while referring to the reference values. It should be noted that setting items 715 through 720 in FIG. 5B are groups of the values that are related to one another among the unique setting values.

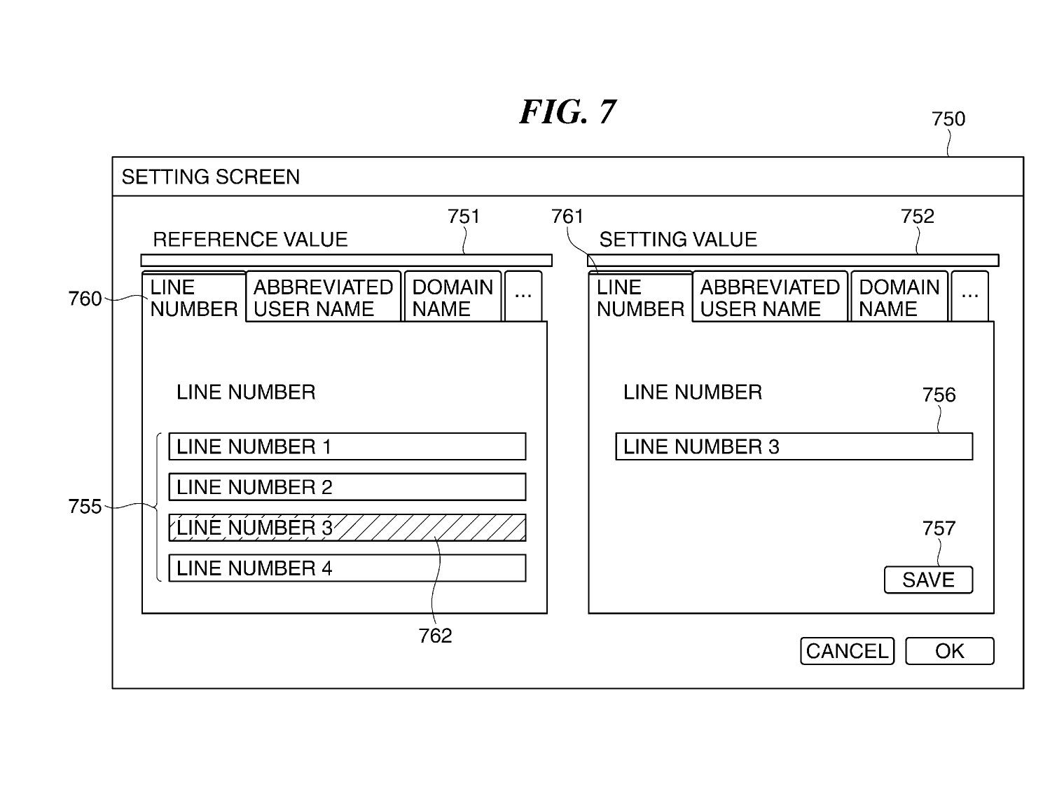

FIG. 7 is a view showing an example of a screen for setting the unique setting values displayed on the operation unit 70 of the image processing apparatus 210.

As shown in FIG. 7, a reference area 751, which displays reference values of the client image processing apparatus acquired from the image processing apparatus 101, and an input area 752, which is used to input the setting values for the image processing apparatus 210, are displayed in side-by-side in a setting screen 750.

Moreover, when the number of models that are referred to as the reference values is not less than a predetermined number, i.e., when there are three or more models in this case, the reference area 751 and the input area 752 are displayed as stacked layers with tags that are separated by the setting data items. In the reference area 751, columns 755 of the reference values that are acquired from the image processing apparatus 101 (referred to as reference value columns, hereafter) are displayed for the respective models.

In the example of FIG. 7, a line number reference tag 760 is selected among tags in the reference area 751. When the user selects the tab, a line number input tag 761 is displayed in the input area 752. In the line number reference tag 760, reference values are listed in the reference value columns 755. In the shown example, the user selects a value 762 corresponding to a “line number 3” from among the reference value columns 755.

If the value 762 corresponding to the “line number 3” is selected, the “line number 3” is copied to an input column 756 in the input area 751 as the unique setting value.

The user can save the setting by touching a save button 757 in this condition, or can save after editing the value copied to the input column 756.

Thus, the user of the image processing apparatus 210 can display a list of the unique setting values, which are set in the image processing apparatuses of existing clients connected to the image processing apparatus 101 as the server, as the reference values for the respective data items on the operation unit 70.

Moreover, when the user selects a setting item while referring to the reference values in the reference area 751, a tag corresponding to the selected item is automatically displayed in the input area 752. The value selected in the reference area 751 can be copied to the input area 752. Accordingly, the unique setting values can be set up easily.

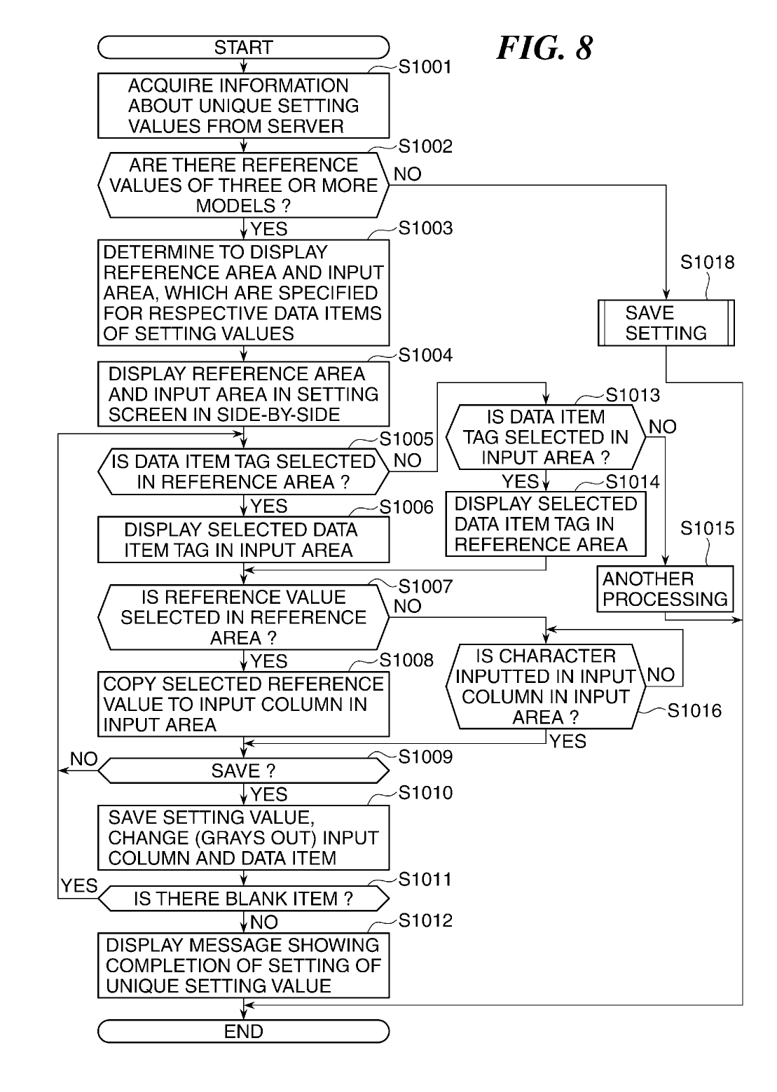

Next, a setting process for the unique setting values in the image processing apparatus 210 as the new client will be described with reference to FIG. 8. Each process in FIG. 8 is realized by loading a control program stored in the ROM, the HDD 65 or the like of the image processing apparatus 210 onto the RAM and by executing the program by the CPU or the like of the control device 60.

In step S1001, the control device 60 acquires information about unique setting values of the image processing apparatuses of existing clients from the image processing apparatus 101 as the server, and proceeds with the process to step S1002.

In step S1002, the control device 60 determines whether the information about unique setting values acquired in step S1001 corresponds to reference values of predetermined number or more models (three or more models) of the image processing apparatuses or not.

And the control device 60 proceeds with the process to step S1003, when the information about unique setting values corresponds to the reference values of the predetermined number or more models (three or more models) of the image processing apparatuses. Moreover, the control device 60 proceeds with the process to step S1018, when the information about unique setting values corresponds to the reference values of the image processing apparatuses of less than the predetermined number models (less than three models). It should be noted that the process in step S1018 will be described later.

In step S1003, the control unit 60 determines to display the setting screen 750 (FIG. 7) that has the reference area 751 and the input area 752, which have the tags for the respective data items of setting values, on the operation unit 70, and proceeds with the process to step S1004.

In step S1004, the control device 60 displays the reference area 751 and the input area 752, which are arranged in side-by-side, for the respective data items of the setting values in the setting screen 750 on the operation unit 70, and proceeds with the process to step 51005.

In step S1005, the control device 60 determines whether any data item tag in the reference area 751 is selected or not. When the tag is selected, the process proceeds to step S1006. When no tag is selected, the process proceeds to step S1013. FIG. 7 shows a screen at the time when the line number reference tag 760 has been selected from the data item tags.

In step S1006, the control device 60 displays the data item tag (the line number input tag 761) selected in step S1005 in the input area 752, and proceeds with the process to step S1007.

In step S1007, the control device 60 determines whether any of the reference values (the “line number 3” 762) is selected from the reference value columns 755 displayed in the reference area 751 or not.

And the control unit 60 proceeds with the process to step S1008 when any of the reference values (the “line number 3” 762) is selected, and proceeds with the process to step S1016 when no reference value is selected.

In step S1008, the control device 60 copies the reference value (the “line number 3”) selected in step S1007 to the input column 756 in the input area 752 as a setting value, and proceeds with the process to step S1009.

In step S1009, the control device 60 determines whether the save button 757 in the setting screen 750 is touched or not. When the save button is touched, the process proceeds to step S1010. When the save button is not touched, the process returns to step S1005.

In step S1010, the control unit 60 saves the setting value copied to the input column 756 in step S1008 into the HDD 65 or the like, notifies the user of the end of setting by graying out the input column 756 and the line number input tag 761, and proceeds with the process to step 51011.

In step S1011, the control unit 60 determines whether there is any blank item or not. When there is any blank item, the process returns to step S1005. When there is no blank item, the process proceeds to step S1012.

In step S1012, the control unit 60 displays a message showing a completion of setting of the unique setting value on the operation unit 70 etc., and finishes the process.

On the other hand, in step S1013, the control device 60 determines whether any data item tag in the input area 752 is selected or not. When the tag is selected, the process proceeds to step S1014. When no tag is selected, the process proceeds to step S1015.

In step S1014, the control device 60 displays the data item tag selected in step S1013 in the reference area 751, and proceeds with the process to step S1007.

In step S1015, the control units 60 determines that another process is needed, and finishes the setting process for the unique setting value.

In step S1016, the control unit 60 determines whether a setting value is inputted into the input column 756 in the input area 752 by characters etc. or not. When any value is inputted, the process proceeds to step S1009.

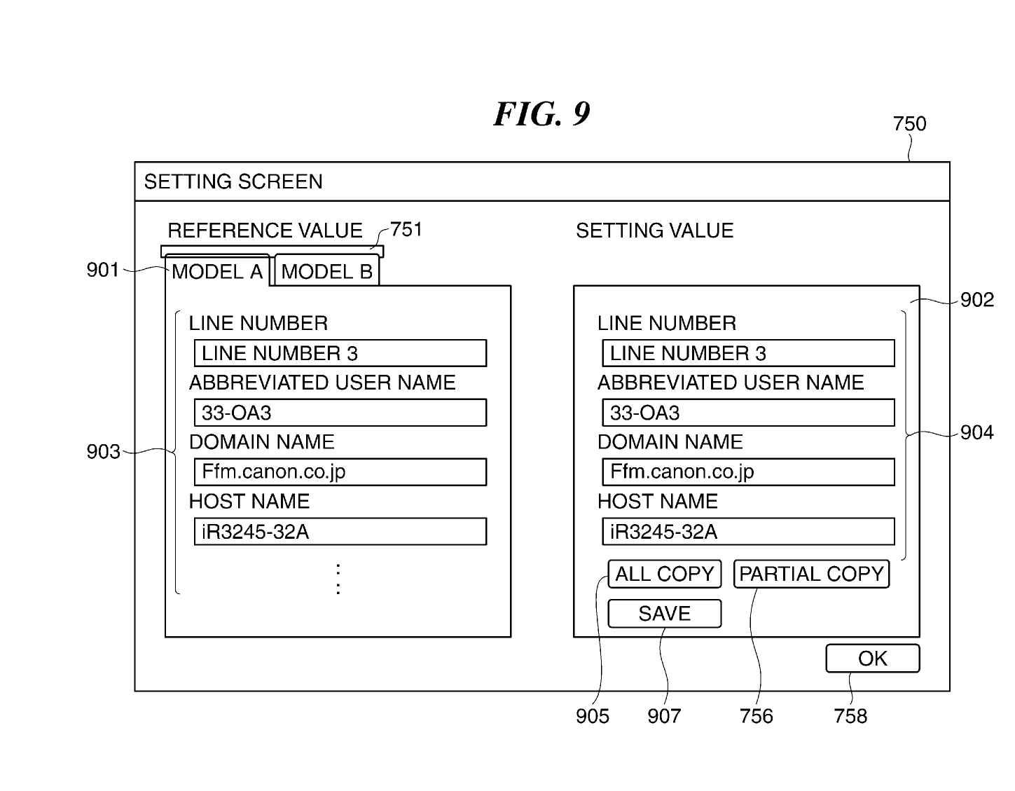

FIG. 9 is a view showing an example of the setting screen 750 displayed on the operation unit 70, when it is determined in step S1002 in FIG. 8 that the information about the unique setting value acquired in step S1001 corresponds to the reference values of two models of image processing apparatuses (No in step S1002).

In the setting screen 750 shown in FIG. 9, the reference area 751 and the input area 902 are displayed side-by-side.

The indication in the reference area 751 is changed and displayed by touching a model tag. For example, a user refers to reference value columns 903 that are established by a model A and a model B of the model tags, and determines that which model sets the nearest values to that of the image processing apparatus 210. In FIG. 9, the model-A tag 901 is selected as a reference model.

When the user refers to the reference value columns 903 of the model-A tag 901 and determines that there are few changing points, the user can touch an all-copy button 905 in the input area 902. When the user touches the all-copy button 905, all the values in the reference value columns 903 of the model-A tag 901 are copied to input columns 904.

After copying, the user edits items that should be edited in the input columns 904 in the input area 902. Then, the user touches a setting completion button 758 to finish the setting.

On the other hand, when the user wants to set specific reference values only among the reference values in the reference value columns 903 in the model-A tag 901, the user can copy necessary reference values only to the input columns 904 as the setting values by touching a partial-copy button 906 after selecting the reference values.

At this time, the user can select and copy only one necessary reference value or can select and copy a plurality of necessary reference values. Either the all-copy or the partial-copy enables to edit the values in the input columns 904 in the input area 902.

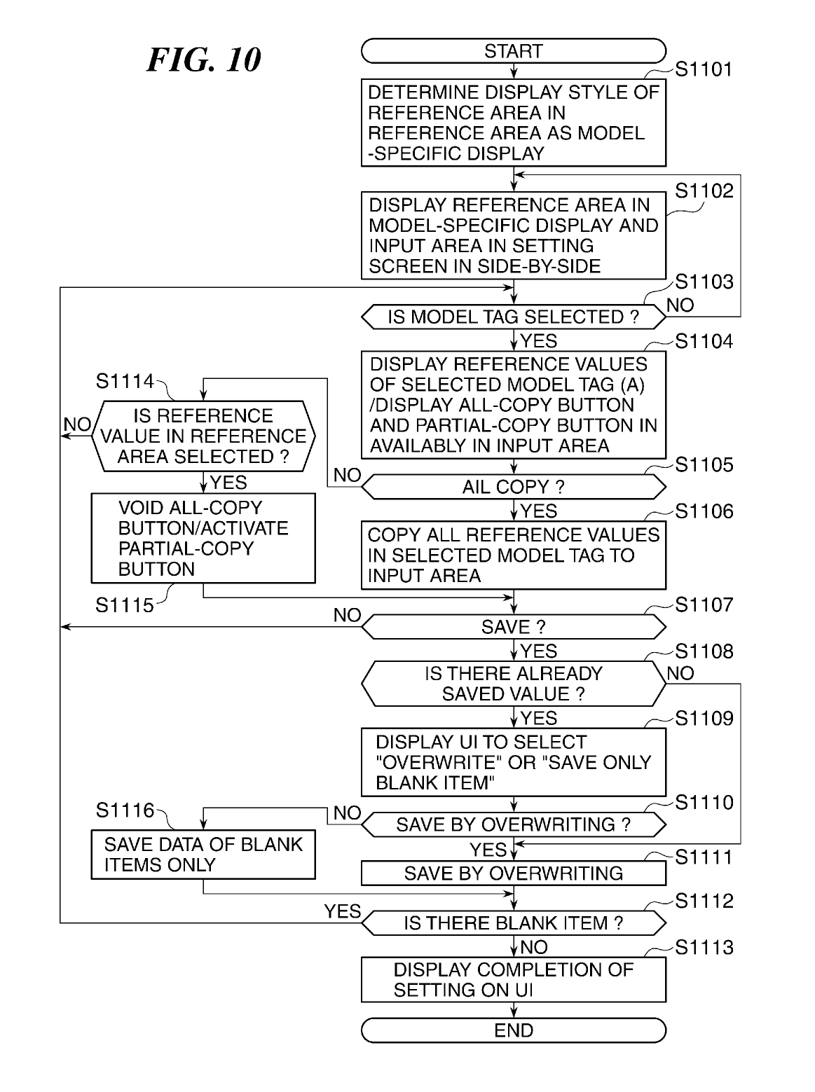

Next, the setting process in step S1018 in FIG. 8 will be described with reference to FIG. 10.

First, in step S1002 in FIG. 8, when the information about unique setting values corresponds to the reference values of the image processing apparatuses of less than three models, the process proceeds to step S1101 in FIG. 10.

In step S1101, the control device 60 determines to display the reference area 751 for the respective models in the setting screen 750 on the operation unit 70, and proceeds with the process to step S1102.

In step S1102, the control device 60 displays the reference area 751 in the model-specific display and the input area 902 in side-by-side (FIG. 9) in the setting screen 750 of the operation unit 70, and proceeds with the process to step S1103.

In step S1103, the control device 60 determines whether any model tag in the reference area 751 is selected by the user or not. When the tag is selected, the process proceeds to step S1104. When no tag is selected, the process is returned to step S1102.

In step S1104, the control device 60 displays the reference value columns 903 of the model tag (the model-A tag 901 in this case) selected in step S1103. The control device 60 displays the all-copy button 905 and the partial-copy button 906 availably in the input area 902, and proceeds with the process to step S1105.

In step S1105, the control device 60 determines whether the all-copy button 905 is touched or not. When the all-copy button is touched, the process proceeds to step S1106. When the all-copy button is not touched, the process proceeds to step S1114.

In step S1106, the control device 60 copies all the reference values in the reference value columns 903 of the selected model-A tag 901 to the input columns 904 in the input area 902 as setting values, and proceeds with the process to step S1107.

On the other hand, in step S1114, the control device 60 determines whether any reference value in the reference value columns 903 is selected or not. When the reference value is selected, the process proceeds to step S1115. When no reference value is selected, the process is returned to step S1103.

In step S1115, the control device 60 voids the all-copy button 905, and displays only the partial-copy button 906 availably in the input area 902.

When the partial-copy button 906 is touched, the control device 60 copies the reference values selected in step S1114 to the input columns 904 in the input area 902 as setting values, and proceeds with the process to step S1107.

In step S1107, the control device 60 determines whether a save button 907 is touched or not. When the save button 907 is touched, the process proceeds to step S1108. When the save button 907 is not touched, the process returns to S1103.

In step S1108, the control unit 60 determines whether new setting values conflict with the setting values that have been already saved or not. When there is a conflict, the process proceeds to step S1109. When there is no conflict, the process proceeds to step S1111.

In step S1109, the control device 60 displays a selection UI (user interface) that indicates an “overwrite” button and a “saving only blank item” button on the operation unit 70, and proceeds with the process to step S110.

In step S1110, the control device 60 proceeds with the process to step S1111 when the “overwrite” button is touched in the selection UI. When the “saving only blank item” button is touched in the selection UI, the process proceeds to step S1116.

In step S1111, the control device 60 overwrites the old setting values in the HDD 65 etc. with the new setting values copied to the input columns 904 in the input area 902, and proceeds with the process to step S1112. It should be noted that when determining that there is no conflict in step S1108, the control device 60 saves the setting values copied to the input columns 904 in the input area 902 into the HDD 65 etc.

On the other hand, in step S1116, the control device 60 saves the setting values corresponding to the blank items only among the setting values copied to the input columns 904 in the input area 902 into the HDD 65 etc., and proceeds with the process to step S1112.

In step S1112, the control unit 60 determines whether there is any blank item or not. When there is any blank item, the process returns to step S1103. When there is no blank item, the process proceeds to step S1113.

In step S1113, the control unit 60 displays a UI showing a completion of setting on the operation unit 70, and finishes the process.

As described above, in this embodiment, when inputting the unique setting values to the image processing apparatus 210 as the new client, the reference area, which displays the reference values acquired from the image processing apparatuses as the existing clients, and the input area, which is used to input the unique setting values, are displayed on the operation unit 70 in side-by-side.

Accordingly, the user can copy the reference value to the input area, edit the copied value, or input a new unique setting value while referring to the reference area. Therefore, the burden on the user of inputting the unique setting value to the image processing apparatus 210 that is newly added to the system can be reduced significantly.

Since the indication in the reference area in the setting screen of the operation unit 70 is changed according to the number of models of the image processing apparatus as the existing clients, user's convenience of the input operation of the unique setting values can be improved.

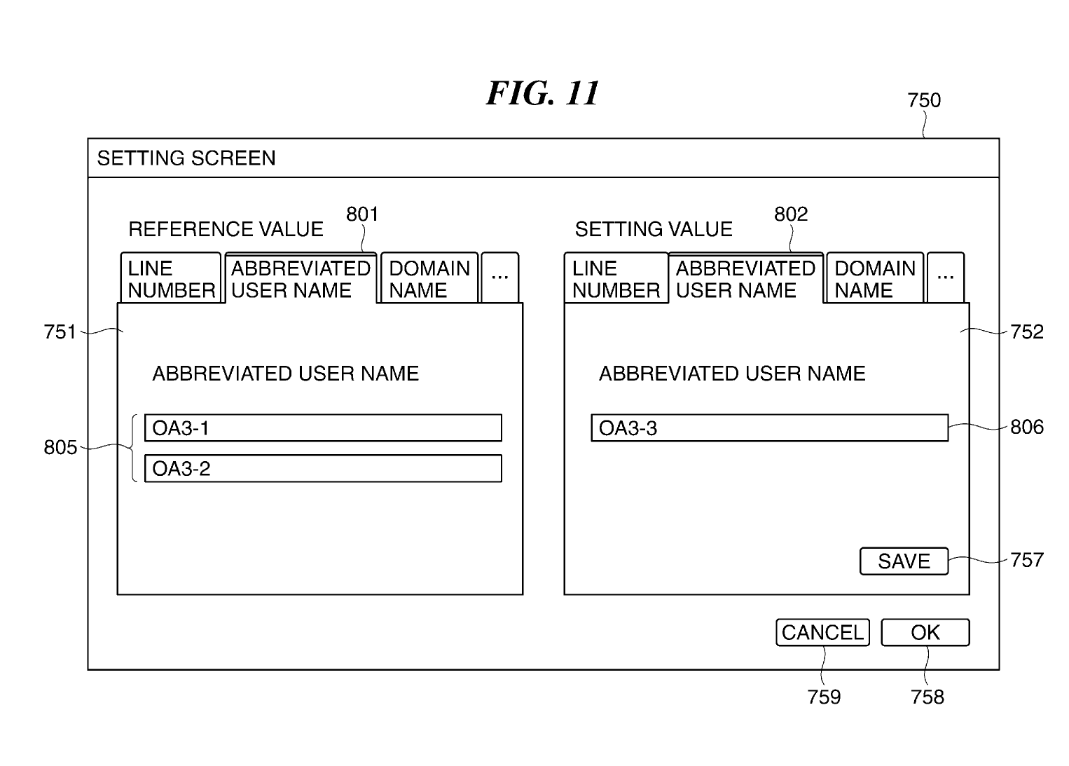

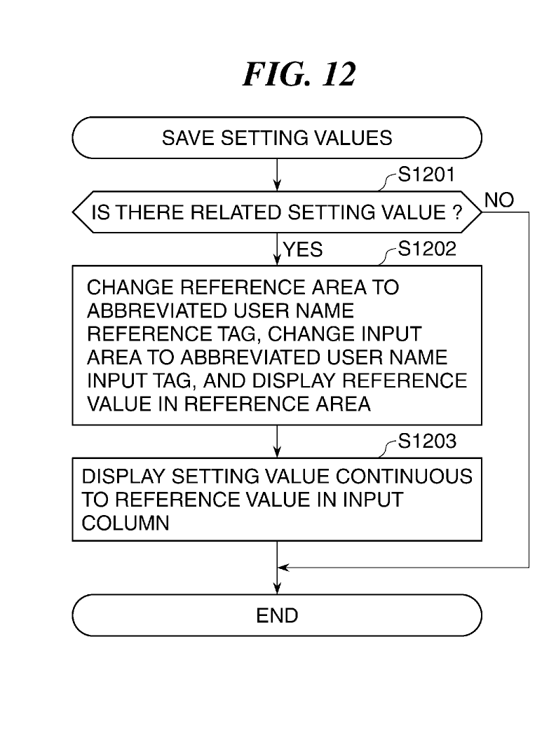

Next, an image processing system that employs an image processing apparatus according to a second embodiment of the present invention will be described with reference to FIG. 11 and FIG. 12. It should be noted that duplicated sections or corresponding section with respect to the above-mentioned first embodiment will be described by diverting the figures and the reference numerals.

In this embodiment, a process executed by the control device 60 instead of step S1010 in FIG. 8 will be described.

In FIG. 5B and FIG. 6, each of the setting items of the unique setting values 714 has setting items (for example, the setting items 715 through 720) that are preferably set in relation therewith. For example, the setting item 715 of a facsimile will be described. In a facsimile machine, line numbers and abbreviated user names are set. In some cases, same abbreviated user name is applied to a plurality of image processing apparatuses that use common line number. In other cases, different abbreviated user names are applied to a plurality of image processing apparatuses that use common line number, respectively.

Therefore, when the existing line number is assigned to the image processing apparatus 210 as the new client, the reference values of the related abbreviated user names are displayed, and setting values of related items are automatically displayed as candidate values. The related item is associated by a relation value ID 730, as shown in FIG. 6.

In this embodiment, a case where different abbreviated user names are applied to a plurality of image processing apparatuses that use the common line number will be described.

When the user establishes the “line number 3” in the input column 756 in the input area 752 as shown in FIG. 7, data item tag in the reference area 751 is changed to a abbreviated user name reference tag 802 as shown in FIG. 11. Also the data item tag in the input area 752 is changed to an abbreviated user name input tag 801.

Reference value columns 805 in the reference area 751 after the change represent that two image processing apparatuses as the existing clients are assigned to the “line number 3”, an abbreviated user name of one apparatus is “OA3-1”, and an abbreviated user name of the other apparatus is “OA3-2”.

In this embodiment, since each individual abbreviated user name is assigned to each image processing apparatus, a new abbreviated user name “OA3-3” is automatically displayed in an input column 806 in the input area 752 as a continuation of the existing names “OA3-1” and “OA3-2”.

The user can save the abbreviated user name by touching the save button 757 in this condition, or can save the abbreviated user name after changing to another abbreviated user name by touching the save button 757 after editing in the input column 806.

Next, a process executed by the control device 60 instead of step S1010 in FIG. 8 will be described with reference to FIG. 12.

In step S1201, the control device 60 determines whether there is a reference value for the abbreviated user name of the unique setting value in relation to the “line number 3”, after saving the setting value “line number 3” or not.

If the related reference value exists, the control device 60 proceeds with the process to step S1202. If there is no related reference value, the control device 60 finishes the process.

In step S1202, the control device 60 changes the data item tag in the reference area 751 to the abbreviated user name reference tag 801, and changes the data item tag in the input area 752 to the abbreviated user name input tag 802 (FIG. 11).

The control device 60 displays the reference value of the abbreviated user name corresponding to the “line number 3” of the image processing apparatuses as the existing clients on the reference value columns 805 in the reference area 751, and proceeds with the process to step S1203.

In step S1203, the control device 60 displays the setting value, which is continuous to the reference values in the reference columns 805, in the input column 806 in the input area 752, and finishes the process.

As described above, in this embodiment, when inputting the unique setting values to the image processing apparatus 210 as the new client, the unique setting value can be inputted easily without thought on the relation to the setting values of the image processing apparatuses as the existing clients.

It should be noted that the present invention is not limited to what has been shown as examples in the above-mentioned embodiments, and can change suitably within the scope that does not deviate the gist of the present invention. In the above-mentioned embodiments, although the MFP or the SFP are described as an example of the image processing apparatus, the image processing apparatuses may be a scanner device, a facsimile machine, a personal computer, or a portable information device such as a mobile phone.

### Other Embodiments

Aspects of the present invention can also be realized by a computer of a system or apparatus (or devices such as) a CPU or MPU that reads out and executes a program recorded on a memory device to perform the functions of the above-described embodiments, and by a method, and the steps of which are performed by a computer of a system or apparatus by, for example, and reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The application claims the benefit of Japanese Patent Application No. 2009-000878, filed on Jan. 6, 2009, which is hereby incorporated by reference herein in its entirety.

What is claimed is:

1. An image processing apparatus that is connected to a network to communicate with a plurality of other image processing apparatuses that exist on the network, the image processing apparatus comprising:
an acquisition unit adapted to acquire a unique setting value from at least one selected from the other image processing apparatuses via the network, the unique setting value being unique to the selected image processing apparatus among setting values set to the selected image processing apparatus concerned; and
a display unit adapted to display a setting screen that includes a reference area for displaying the unique setting value acquired by said acquisition unit as a reference value, and an input area for inputting the unique setting value that is set up to the image processing apparatus itself.

2. The image processing apparatus according to claim 1, wherein said display unit displays the reference area and the input area as stacked layers that are separated by data items of the unique setting values when a number of the selected image processing apparatuses is not less than a predetermined number.

3. The image processing apparatus according to claim 1, wherein said display unit displays the reference area as stacked layers that are separated for every existing image processing apparatus when a number of the selected image processing apparatuses is less than a predetermined number.

4. The image processing apparatus according to claim 2, further comprising a determination unit adapted to determine whether there is a reference value corresponding to the data item of the unique setting value that is a setting target in the input area or not,
wherein said display unit changes the layers in the reference area and the input area to layers of another data item when said determination unit determines that there is a reference value.

5. The image processing apparatus according to claim 4, wherein said display unit displays a setting value, which is determined based on the reference value displayed in the reference area, in the input area.

6. The image processing apparatus according to claim 1, further comprising a copying unit adapted to copy the reference value displayed in the reference area to the input area as a setting value according to an operation of a user; and
an editing unit adapted to edit the setting value copied to the input area by said copying unit according to an operation of the user.

7. The image processing apparatus according to claim 1, further comprising a setting unit adapted to acquire a common setting value, which is common among the apparatuses, from the selected image processing apparatus and to set the common setting value as a setting value of the image processing apparatus itself.

8. The image processing apparatus according to claim 1, wherein said acquisition unit acquires the unique setting value via a server that is existed on the network.

9. A control method for an image processing apparatus that is connected to a network to communicate with a plurality of other image processing apparatuses that exist on the network, the control method comprising:
an acquisition step of acquiring a unique setting value from at least one selected from the other image processing apparatuses via the network, the unique setting value being unique to the selected image processing apparatus among setting values set to the selected image processing apparatus concerned; and
a display step of displaying a setting screen that includes a reference area for displaying the unique setting value acquired in said acquisition step as a reference value, and an input area for inputting the unique setting value that is set up to the image processing apparatus itself.

10. A computer-readable storage medium storing a control program to execute a control method for an image processing apparatus that is connected to a network to communicate with a plurality of other image processing apparatuses that exist on the network, the control method comprising:
an acquisition step of acquiring a unique setting value from at least one selected from the other image processing apparatuses via the network, the unique setting value being unique to the selected image processing apparatus among setting values set to the selected image processing apparatus concerned; and
a display step of displaying a setting screen that includes a reference area for displaying the unique setting value acquired in said acquisition step as a reference value, and an input area for inputting the unique setting value that is set up to the image processing apparatus itself.
